(19) United States
(12) Patent Application Publication
(10) Pub. No.: US 2017/0087580 A1
(43) Pub. Date: Mar. 30, 2017

(54) Multipurpose, Adjustable, Portable Stand

(71) Applicant: John Patrick Griffin, Sykesville, MD (US)

(72) Inventor: John Patrick Griffin, Sykesville, MD (US)

(21) Appl. No.: 15/362,162

(22) Filed: Nov. 28, 2016

Related U.S. Application Data
(63) Continuation-in-part of application No. 14/494,885, filed on Sep. 24, 2014.

(51) Int. Cl. B05B 15/06; F16L 3/18; F16L 3/00; B05B 3/04; A01G 25/00; A01G 13/02; E04H 17/02; E04H 15/34; F16M 11/28; A01G 27/00

(52) U.S. Cl. CPC B05B 15/068; F16M 11/28; F16L 3/18; F16L 3/003; A01G 27/00; A01G 25/00; A01G 13/0206; E04H 17/02; E04H 15/34; B05B 3/0486

(57) ABSTRACT

A multi-faceted multi-task system for horticultural adaptations including water dispersion and irrigation, animal and plant/crop protection, and plant shading, which allows a user to operate an irrigation system or a radial misting apparatus while using a tarp for shade and construct a fence to create an animal control zone. The present device features a telescoping main pole that can be adjusted to different heights to fit any situation. The device is highly portable as it can be folded up onto itself and carried to a destination by hand and provides water dispersion for irrigation and temperature control, while offering users the opportunity to construct a shade and/or animal control zone. A ball containment system for athletic activities.

### CROSS REFERENCE TO RELATED APPLICATION

This application is a continuation-in-part and claims the benefit of and takes priority from U.S. Utility application Ser. No. 14/494,885 filed on Sep. 24, 2014, which in turn claims the benefit of and takes priority from U.S. Provisional Application Ser. No. 61/881,540 filed on Sep. 24, 2013, the contents of which are hereby incorporated by reference.

### FIELD OF THE INVENTION

The present system and series of accompanying apparatuses relate to horticultural assist systems, and particularly a water distribution, shade protection and animal protection system for the horticultural, agricultural and sports sectors to irrigate plants and gardens, regulate temperatures, and create control zones against animals, as well as provide ball containment systems for athletic activities.

### BACKGROUND OF THE INVENTION

There are a variety of devices that are known for dispersing water around an area and some include stands that may elevate a system head to provide a better radius of dispersion. Since the dawn of farming ten thousand years ago in the Neolithic era, the need to regularly and efficiently hydrate and nourish crops that have been planted has existed.

In the initial years, planting was intentionally situated in proximity to river beds where the water table was high enough to provide the proper amount of moisture. Additionally, the ancient Egyptians implemented a similar technique by planting with the flooding cycle of the mighty Nile River, allowing the Nile to supply both water and nutrients for their crops.

As farming became more heavily relied upon for survival of villages and nations alike, farmers started to move away from river beds and into fields making irrigation more important. Eventually, channels and aqueducts for diverting water from rivers and streams were created to water the farmland. Subsequently, via gravity and pumping devices, water pressure systems were designed to push water out of pipes, effectively creating the first system. Today systems are used for much more than just shuttling water to crops; it is also used to control temperatures of cattle, athletic participants, and crowds.

Concurrent systems for the dispersal of fluids in the areas of agriculture and grass growth can be classified into numerous categories. In some embodiments, a series or system of piping comprising a small diameter and a height normally less than four (4) feet, either staked into the ground or attached to a larger pipe. The systems in this category are often not portable because they are frequently in fluid communication, integrated into, or attached to rigid water lines, or deeply imbedded into the soil to provide the needed stability. Additionally, the height and positioning of these systems renders them at a disadvantage to disperse water over a larger area, making it necessary for multiple units to be used to cover a specific area. The low height of the systems in this category only work for small crops/plants and cannot be used to create cooling zones for athletes or livestock because the water is not dispersed high enough and/or in a controlled consistency and volume to be effective.

Another category of water system systems may be classified as large movable apparatuses on wheels possessing the ability to discharge large amounts of water at high pressure out of a pivoting metal nozzle. This type of fluid dispersal system is adequate at covering large swaths of land with adequate amounts of water but there are several drawbacks. The high pressure of the system renders this system unusable for lawn and athletic venues as well as agricultural use in cattle yards and newly seeded plots or patches where delicate plants are growing, as the large amounts of water will create muddy, saturated and potentially unsanitary areas for cattle and drown or damage plants. The portability of these systems is limited because of their bulkiness and can only be moved by a motorized vehicle, making placement of the system limited to areas cleared to allow vehicles access.

An additional category of systems includes large mechanized rolling water disbursement platforms that are either attached to a central location or move freely along a preplanned route. These systems are designed to function in large acreage farms and are not portable, as they must be assembled and disassembled on location. This category delivers water through hanging tubes or pipes that mist plants from above. It is not practical for anything other than watering crops.

The final category discussed herein includes systems more akin to the instant fluid dispersal and horticultural protection systems that can be grouped into small ground based systems that are portable. These systems include the typical residential lawn dispersal system, crowd misters, or other small pivoting water dispersion devices. These are often used to water residential lawns and small gardens or cool crowds and athletes, and due to the units being ground based they cannot get the same trajectory as taller systems that cover a greater area and are not blocked by low obstacles. A water dispersion system that may be easily transported, may be adjusted to great heights, may provide coverage for large areas, and does not need to be towed to locations or mechanized for operation is vital.

When properly designed and managed, the center pivot and linear move irrigation systems may be the most efficient type of sprinkler irrigation systems. The foundation of their efficiency is the result of locating the sprinklers above the crop canopy which reduces foliage damage resulting from high pressure single streams of water distributed from below the plant material. Further they produce high instantaneous application rates all while maintaining good application uniformity. Sprinklers, such as Rotators, Spinners, and Wobblers, installed with proper distribution heights, reduce the number of water streamlets and water pressure requirements which increase the water drop size and water throw distance (zone) resulting in reducing wind drift and spray evaporation. Compared to other sprinklers available for commercial and agricultural irrigation, wobbling sprinklers operate extremely well in low pressure applications which are highly desirable as it leads to lower operating costs.

The center pivot and linear move irrigation systems were designed for large field applications where the plant material resides in the ground; however, there is a significant need to irrigate plant material in a similar fashion that reside in plastic or wood containers and/or balled and burlap (B&B) methods that reside above the ground and are mobile, as well as, small in-ground plant material plots. Typical areas where one can apply similar irrigation methods in single sprinkler head methods are garden centers, landscaping operation yards and on site applications, nursery staging and holding areas and smaller plots of land such as farming and residential vegetable and/or flower gardens. Of importance, these areas deal with plant material that is mobile, of varying heights, varying foliage textures, seasonal and for a number of reasons usually do not have hard water pipes as a means of water transport to the sprinkler.

### SUMMARY OF THE INVENTION

The instant apparatus and system, as illustrated herein, is clearly not anticipated, rendered obvious, or even present in any of the prior art mechanisms, either alone or in any combination thereof. The versatile system, method and series of apparatuses for creating and utilizing a series of systems and apparatuses comprising a fluid dispersal system which additionally encompasses additional protection from animals and the elements are illustrated. Thus the several embodiments of the instant apparatus are illustrated herein.

It is therefore an objective of the instant system to create a fluid dispersal and temperature cooling environment via the dispersion of water to satisfy irrigation and plant protection needs for horticultural purposes.

It is therefore an objective of the instant system to create a fluid dispersal and temperature cooling environment via the dispersion of water to satisfy temperature and animal protection needs for agriculture purposes.

Additionally, it is an object of the instant system to irrigate plant material, through customizable methods, in single source sprinkler applications that improve and expedite irrigation practices.

It is also an objective of the instant system to introduce a free standing, adjustable mechanism to provide water dispersion, a shade zone, and an animal and/or plant protection system in the same device. An additional objective of the instant system to introduce a ball containment system for athletic activities.

It is an further object of the instant system to transform water into efficient and economical irrigation droplets of varying sizes in an all-inclusive zone to satisfy the requirements of a wide variety of plant material in custom retail, nursery, landscaping and backyard environments.

Additionally, it is an objective of the instant system to provide an apparatus comprising a PowerPost™ Mounting Bracket and PowerPost that is used as a cooling station for athletes, fans, customers, agricultural animals and others when situated in hot weather conditions.

An additional objective of the instant system is to provide adequate irrigation for plants/crops by a system with head(s) situated on top to spray water down/across onto plants by introducing a multipurpose adjustable pole, constructed of a metal alloy, has two parts main pole and the secondary pole which fits inside the main pole and can be heightened or lowered via a push pin mechanism that is integrated with a corresponding aluminum profile channel pipe mentioned hereinafter that secures the two poles together.

An additional object of the instant system is to irrigate plant material above its canopy with a minimum evaporation loss of the water, lowest possible energy use and by instantaneous application of the water so as to create an expeditious means of the water to ultimately reach the plants root zone by means that are customizable to any environment.

Additionally, it is the object of the system to be easily and quickly attached to any fixed or mobile support structure of a custom height, size and/or form that provides a suitable base, stand or means to dampen or completely eliminate the vibration of the rotary action of the sprinkler all while providing the means for the dispersion of the water above the plant material in a horizontal manner relative to the ground. Further, the system can disperse water from the side of the plant material in a vertical manner relative to the ground. Ideal applications of this manner include where the plant material resides within multi-shelved plant racks that diminish or eliminate overhead irrigation processes.

It is an additional object of this system to be utilized without the need of any hard pipe as the means of transporting water to the sprinkler resulting in a very mobile and customizable water distribution unit.

Additionally, it is an objective of the instant system to create a fluid dispersal and temperature cooling environment, via the dispersion of water, that is sturdy.

Furthermore, it is an objective of the instant system to create a fluid dispersal and temperature cooling environment, via the dispersion of water, that is compact.

It is an additional an objective of the instant system to create a fluid dispersal and temperature cooling environment, via the dispersion of water, that is durable.

Additionally, it is an objective of the instant system to create a fluid dispersal and temperature cooling environment, via the dispersion of water, that is lightweight.

It is also an objective of the instant system to create a fluid dispersal and temperature cooling environment, via the dispersion of water, that is safe.

An additional objective of the instant system to create a fluid dispersal and temperature cooling environment, via the dispersion of water, that is efficient.

Furthermore, it is an objective of the instant system to create a fluid dispersal and temperature cooling environment, via the dispersion of water, that is versatile.

Additionally, it is an objective of the instant system to create a fluid dispersal and temperature cooling environment, via the dispersion of water, that is ecologically compatible.

Moreover, it is an objective of the instant system to create a fluid dispersal and temperature cooling environment, via the dispersion of water, that is energy conserving.

It is also an objective of the instant system to create a fluid dispersal and temperature cooling environment, via the dispersion of water, that is reliable.

An additional objective of the instant system to create a fluid dispersal and temperature cooling environment, via the dispersion of water, that is easy to manufacture, install, adjust, operate and maintain.

It is a further object of the instant system to provide a shade zone via a tarp or shade cloth.

Also an object of the instant system is to provide a fence to create a barrier against animals.

Additionally, it is an object of the instant system to receive individual or multiple number counts of various size water pressure regulators that can be connected/disconnected by hand and/or with common hand tools to maximize sprinkler performance.

An additional object of the instant system to receive individual or multiple number counts of various size sprinkler heads and types that can be connected/disconnected by hand and/or common hand tools to the system.

It is also an additional object of the instant system to receive individual or multiple number counts of various size water source pipe and/or hose types that can be connected/disconnected by hand and/or with common hand tools to the system.

Additionally, it is an object of the instant system to have the capability to receive hardware at an angle, upright or inverted sprinkler heads for upward, downward or sideways water applications.

Furthermore, it is an object of the instant system to use unique methods of the mounting of the PVC connections (bushing and swivel) to the angle bracket dampen in order to tolerate the vibration of the sprinkler, allow for simple tightening of hoses, sprinklers, water pressure regulators, all while remaining fixed and stationary under normal operating conditions.

It is also an object of the system to prevent vibration from the sprinkler head from being transmitted to the water supply pipe/hose, as well as, the structural support device it is attached to.

Moreover, the instant system applies to differing forms and attachments in order to create advantageous and/or appealing user applications within numerous prescribed industries. Some examples may include, but are in no way limited to, design and/or attachment variances in order to obtain angle, height and/or tool application attachment advantages and/or uses such as, but in no way limited to video cameras, picture cameras, lightening detection devices, lights, motion detection devices, boundary/perimeter sensor devices, radar, weather sensing devices.

These together, with the other objectives of the device, along with the various features of novelty, which characterize the apparatus, are pointed out with particularity in the claims annexed to and forming a part of this disclosure. For a better understanding of the mechanism, its operating advantages, and the specific objectives attained by its use, study of the accompanying drawings and descriptive matter, in which there are illustrations of the preferred embodiments, should be conducted.

There has thus been outlined, rather broadly, the more important features of the versatile integrated system, and series of accompanying systems and apparatuses and embodiments in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

To the accomplishment of the foregoing and related ends, certain illustrative aspects are described herein in connection with the following description and the annexed drawings. These aspects are indicative of the various ways in which the principles disclosed herein can be practice and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a telescoping pole and bracket integrating water pressure reducer, wobbler sprinkler and water leader hose for upward water application.

FIG. 2 illustrates a telescoping pole and bracket integrating ticker sprinkler and leader hose.

FIG. 3 illustrates a telescoping pole and bracket integrating ticker sprinkler and leader hose shown with dashed lines to illustrate only the post apparatus.

FIG. 4 illustrates a telescoping pole and bracket integrating ticker sprinkler and leader hose shown with dashed lines to illustrate only the bracket.

FIG. 5 illustrates a telescoping pole displaying base apertures and bracket apertures of various sizes.

FIG. 6 illustrates a telescoping pole side view displaying bracket apertures.

FIG. 7 illustrates a telescoping pole side view displaying opposing bracket apertures view.

FIG. 8 illustrates a top view of one embodiment a telescoping pole to connected to a base, wherein the telescoping pole is hollow and includes a base weep hole in center and remaining base holes used for attachment of unit.

FIG. 9 illustrates a bottom view of one embodiment of a telescoping pole viewing center weep hole and remaining base holes used for attachment of unit.

FIG. 10 illustrates an additional embodiment of a telescoping pole in which the base and upper post separate by means of push pin or similar mechanism which affords for transportability of the upper post, bracket and sprinkler to different base location.

FIG. 11 illustrates an additional embodiment of a telescoping pole in which height of upper post can elevate or lower by telescopic means or similar by utilizing push pin methodology or similar.

FIG. 12 illustrates an additional embodiment of a telescoping pole integrating a net or similar apparatus so as to form boundary, border, containment or similar.

FIG. 13 illustrates an isometric view of one embodiment of a bracket displaying apertures and hardware integration aperture.

FIG. 14 illustrates a side view of one embodiment of a bracket displaying apertures and hardware integration aperture.

FIG. 15 illustrates a top view of an embodiment of a bracket displaying apertures and hardware integration aperture.

FIG. 16 illustrates a bottom view of an embodiment of a bracket displaying apertures and hardware integration aperture.

FIG. 17 illustrates a front view of an embodiment of a bracket displaying apertures and hardware integration aperture.

FIG. 18 illustrates a rear view of an embodiment of a bracket displaying apertures and hardware integration aperture.

FIG. 19 illustrates one embodiment of a bracket mechanism displaying integration of hardware for upwardly mounted sprinkler applications.

FIG. 20 illustrates a Telescoping pole and bracket integrating wobbler sprinkler and water leader hose for inverted water application.

FIG. 21 Bracket integrating water pressure reducer, wobbler sprinkler and water leader hose for upward water application displayed on a wooden post.

FIG. 22 Bracket integrating water pressure reducer, wobbler sprinkler and water leader hose for upward water application displayed on a metal cylindrical post.

### DETAILED DESCRIPTION OF THE INVENTION

The detailed description set forth below is intended as a description of presently preferred embodiments of the invention and does not represent the only forms in which the instant invention may be construed and/or utilized. However, it is to be understood that the same or equivalent functions may be accomplished by different embodiments and are also intended to be encompassed within the scope of the invention. The multipurpose horticultural, agricultural and sports adjustable, collapsible and portable stand may be referred to as the “system.”

The system is designed to uniquely satisfy three (3) critical criteria as a horticultural, agricultural and/or sport system, that includes being wholly collapsible, portable, adjustable and simultaneously multipurpose. First, the system is designed to be collapsible in order to afford the user ease of transport and storage, while fitting into a minimal area. In one embodiment, the telescopic pole may be fully lowered to approximately 7′ to fully heightened approximately 10′, may utilize a push pin mechanism to move up and down in order to achieve precise height, direction and/or location requirements.

Second, the system is designed to be portable in order to allow the unit to be transferred to a specific location as it relates to satisfying a unique need within that environment in a timely and cost efficient manner. Of great importance here, the system can be specific and customized into an environment; hence, the system is a practical and efficient means to save time and ultimately costs.

Third the instant system is designed to be adjustable in numerous embodiments, including heightening requirements as it relates to irrigation and water distribution, shade protection and/or fencing height related to an asset deterrent barrier. The means by which the height is adjusted is a push pin mechanism and/or hand tightening bolt device or key slot connector if utilizing an aluminum profile channel pipe as the upper main post. The push pin is engaged by a single finger to a fully lowered through fully heightened position or single hand to loosen and/or tighten the hardware associated with the key slot connector in order to increase or decrease pressure in order to increase or decrease post height. In one embodiment, the lowered height may range from approximately 7′, 8′, 9′ and fully heightened may reach approximately 10′ or more.

The ability to easily and rapidly exchange out the sprinkler apparatus of the instant system affords the user to customize the individual system to meet and satisfy their specific needs and requirements expeditiously. In the instant system, the telescoping pole may possess varying intended purposes and directives, relative to irrigation, deer fence and/or shade cloth uses and/or attachment variances in order to obtain angle, height and/or tool application attachment advantages and/or uses such as, but in no way limited to video cameras, picture cameras, lightening detection devices, lights, motion detection devices, boundary/perimeter sensor devices, radar, weather sensing devices. Herein, a list of exemplary telescoping pole designs and configurations, not to be construed as limiting, that may serve to satisfy a matrix of irrigation, deer fence and/or shade cloth requirements is as follows:
1. Deer Fence—multiple hooks integrated into the telescoping pole by means of fabrication, welding and/or hardware such as, but in no way limited to, nuts, bolts and/or hand tightening devices.
2. Irrigation—male and female threaded connectors integrated into the telescoping pole to adequately receive various sprinkler heads and water sources such as, but in no way limited to, a typical garden hose, pvc pipe, steel pipe, copper pipe. The means to integrate the aforementioned connectors into the telescoping pole will be by fabrication, welding and/or hardware such as, but in no way limited to, nuts, bolts and/or hose clamps.
3. Shade Cloth—A threaded rod of approximately ⅜″ with a washer to properly receive and suspend a shade cloth by means of typical grommets. The means to secure the shade cloth's grommet to the threaded rod will be, but in no way limited to, an appropriately sized wing nut.

The below list represents, but is not limited to, the matrix of telescoping pole design variations to satisfy single, dual and tri-system configurations as follows:
1. Deer Fence
2. Irrigation
3. Shade Cloth
4. Deer Fence and/or Irrigation
5. Deer Fence and/or Shade Cloth
6. Irrigation and/or Shade Cloth
7. Deer Fence and/or Irrigation and/or Shade Cloth

Each of the following telescoping pole designs will be designed and constructed to satisfy change of direction layouts such as corners and other varying degree angles.

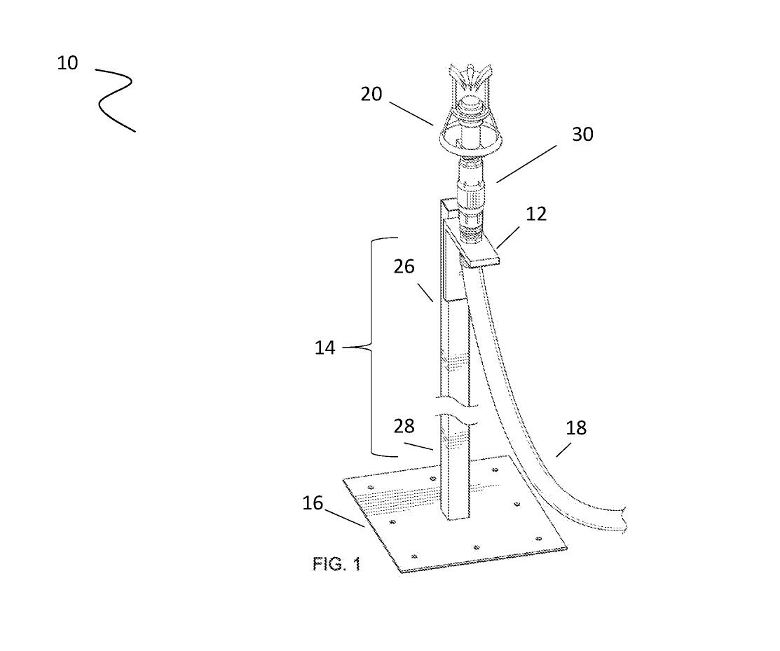

FIG. 1 illustrates one viewpoint of the present apparatus's telescoping pole 26, bracket 12, integrating water pressure reducer 30, wobbler sprinkler and water leader hose for upward water application 10. In one embodiment, the telescoping pole comprises an upper section 26 and a lower section 28. The bracket 12 is in communication with the upper section of the telescoping pole 26 which is in communication with the bottom section 28 which in turn is in communication with the base 16. The bracket 12 is designed to receive different types of system heads like a wobbler sprinkler head 20 and a ticker sprinkler head 24.

The bracket 12 is also designed to receive a water leader hose 18. The bracket 12 is L-shaped with one side in communication with the upper section of the telescoping pole 14, and the perpendicular side extending outward parallel to the ground. The bracket 12 is secured using removable hardware to ensure the attachments stay in place. The wobbler sprinkler 20 is in communication with the bracket 12.

In some embodiments, the bracket may be moulded as a solid single piece of material capable of receiving various size sprinkler heads and various size hose fittings. In further metallic embodiments, die-casting and forging may be utilized as means of manufacturing. In additional embodiments featuring polymeric members, injection molding or extrusion or other such methods may be utilized. Moreover, in composite embodiments, for example in use of materials such as carbon fibre, weaving techniques may be utilize.

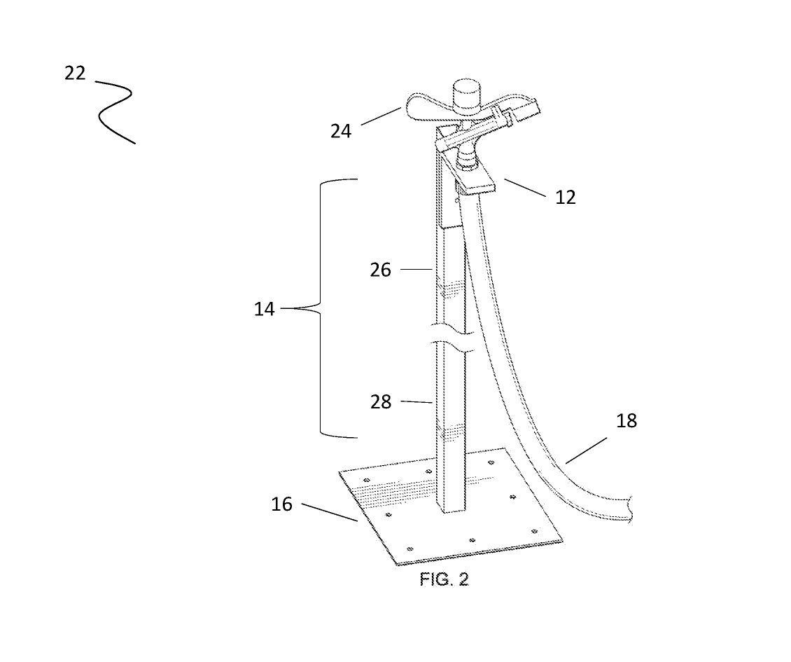

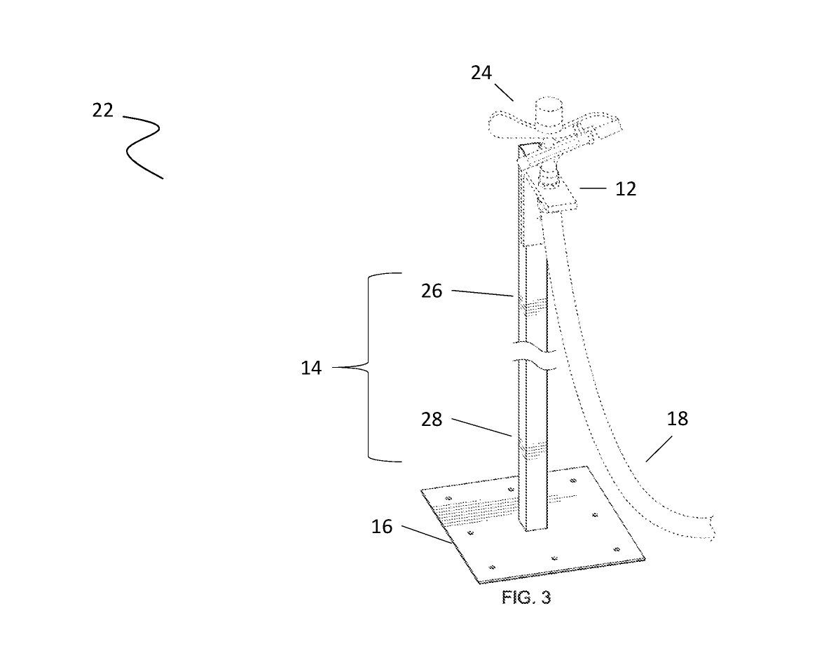

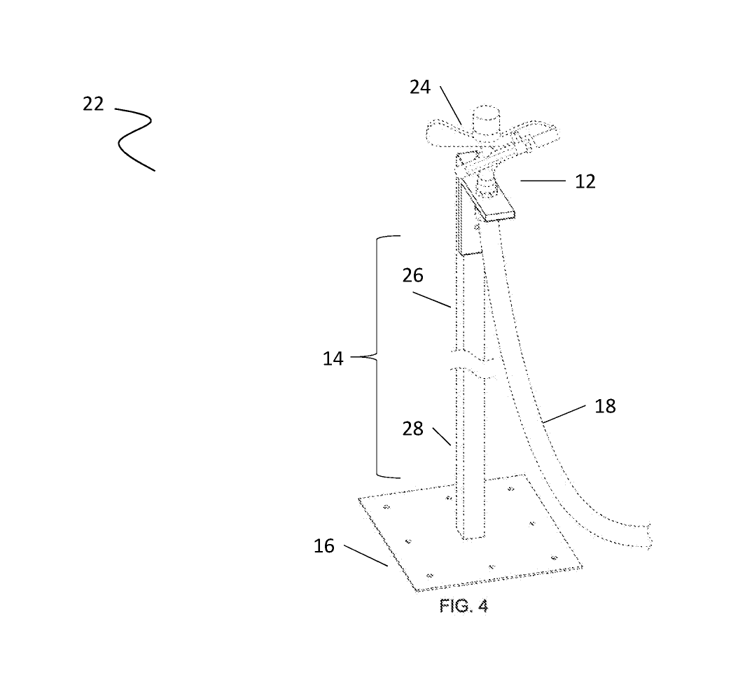

FIGS. 2-4 illustrate various viewpoints of the present apparatus's telescoping pole, bracket, integrating water pressure reducer 30, ticker sprinkler and water leader hose for upward water application 22. The ticker sprinkler 24 is in communication with the bracket 12.

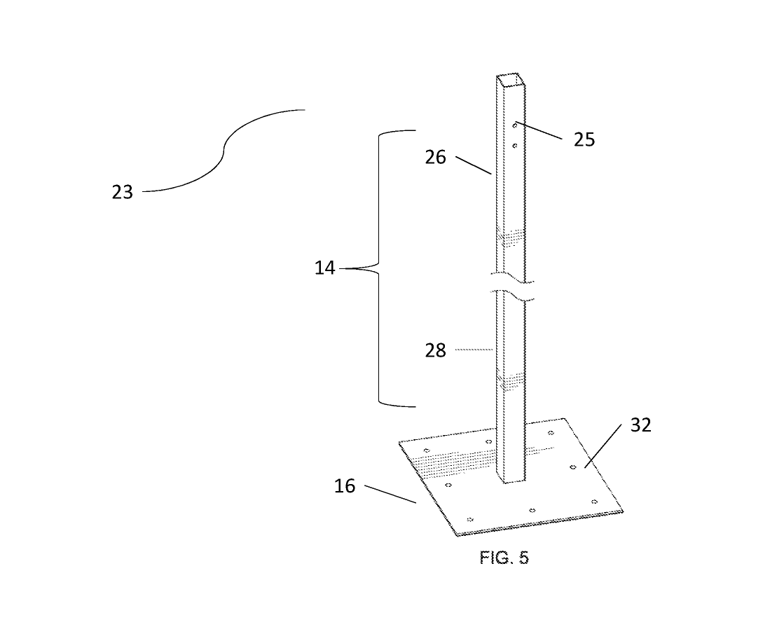

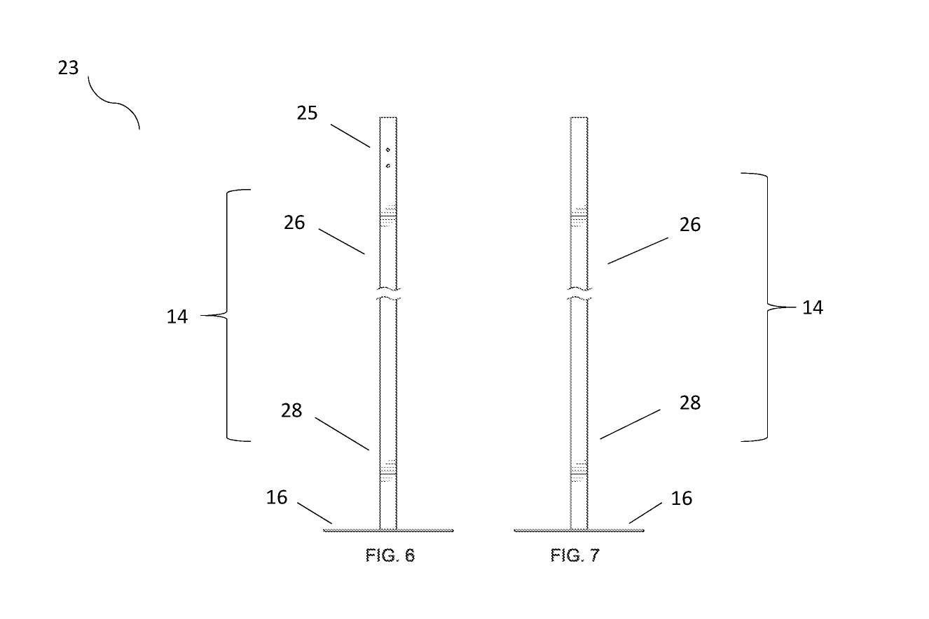

FIGS. 5-7 illustrate various viewpoints of the present apparatus's telescoping pole 14 and base 16 with FIG. 6 illustrating a front view and FIG. 7 illustrating a rear view. The figures illustrate one embodiment of the telescoping pole comprising two sections; an upper section 26 which fits within the lower section 28. The upper section 26 comprises at least one aperture 27. The base 16 also comprises at least one aperture 32. Both sections are constructed of a metal alloy that is strong and light enough to be portable.

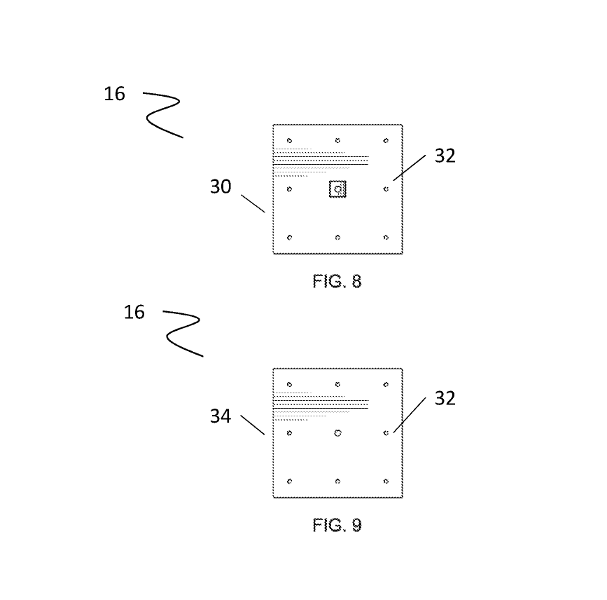

FIGS. 8-9 illustrate various viewpoints of the present apparatus's base 16, with FIG. 8 illustrating a top view and FIG. 9 illustrating a bottom view. The figures illustrate a top view of the hollow telescoping pole 14 with a view down to the base weep hole 30 in the center and at least one aperture 32, spaced equidistant apart around the perimeter of the base, used for securing of telescoping pole 14. The figures also show the bottom view of center weep hole 34 and at least one aperture 32.

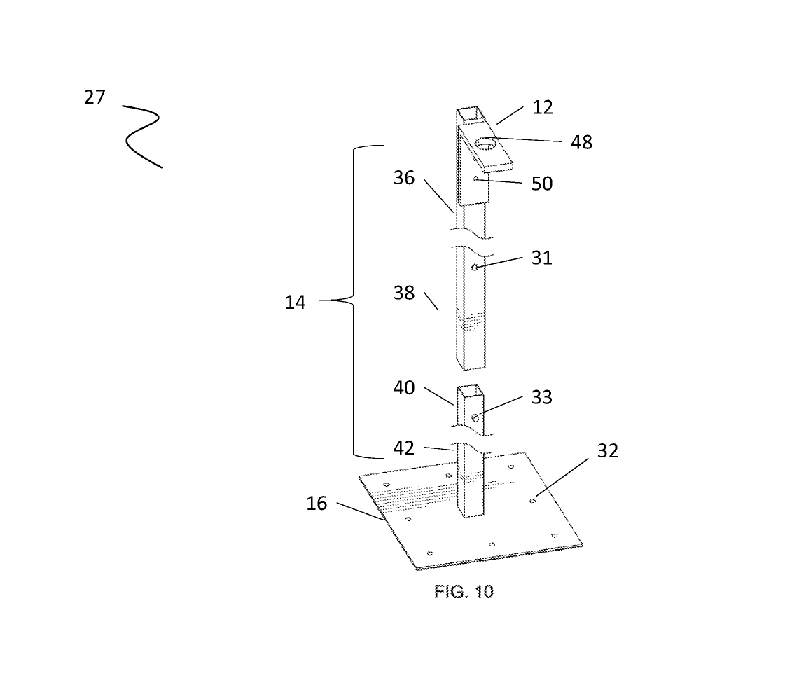

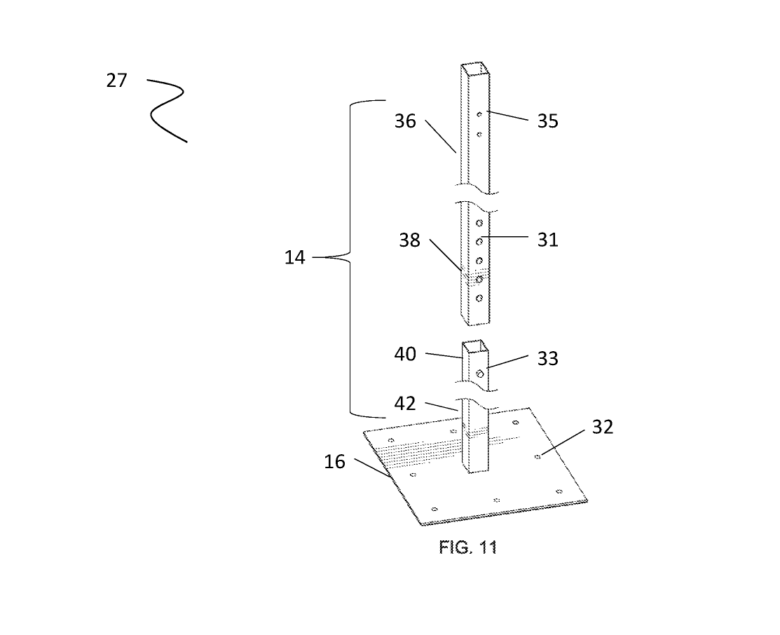

FIGS. 10-11 illustrate various viewpoints of the present apparatus's telescoping pole 14, bracket 12 and base 16, with FIG. 10 illustrating a front view and FIG. 11 illustrating a rear view. In one embodiment, the telescoping pole comprises a first section 36, a second section 38, a third section 40, and a fourth section 42 to illustrate the versatility in height that can be achieved by lowering or raising each section within the telescoping pole. The first section 36 is in communication with the bracket 12. The first section 36 is also in communication with the second section 38 by fitting within the second section 38. The first section 36 comprises at least one aperture, wherein the apertures are spaced equidistant apart. The third section 40 is in communication with the second section 38 by fitting within the second section 38. The second section 38 comprises at least one aperture, wherein two or more apertures are spaced equidistant apart. The third section 40 comprises at least one push pin mechanism. The third section 40 is in communication with the fourth section 42 by fitting within the fourth section 42. The fourth section 42 is in communication with the base 16.

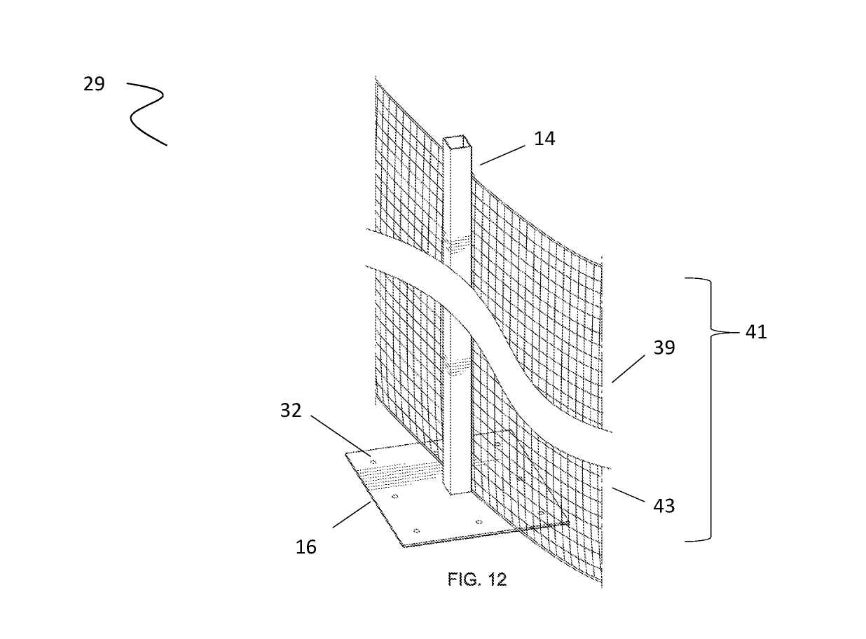

FIG. 12 illustrates one embodiment of the telescoping pole 14 supporting a tarp or other protective mechanism 39. The tarp is in communication with the telescoping pole 14. In one embodiment, the tarp is comprised of two sections, a top section 41 and a bottom section 42.

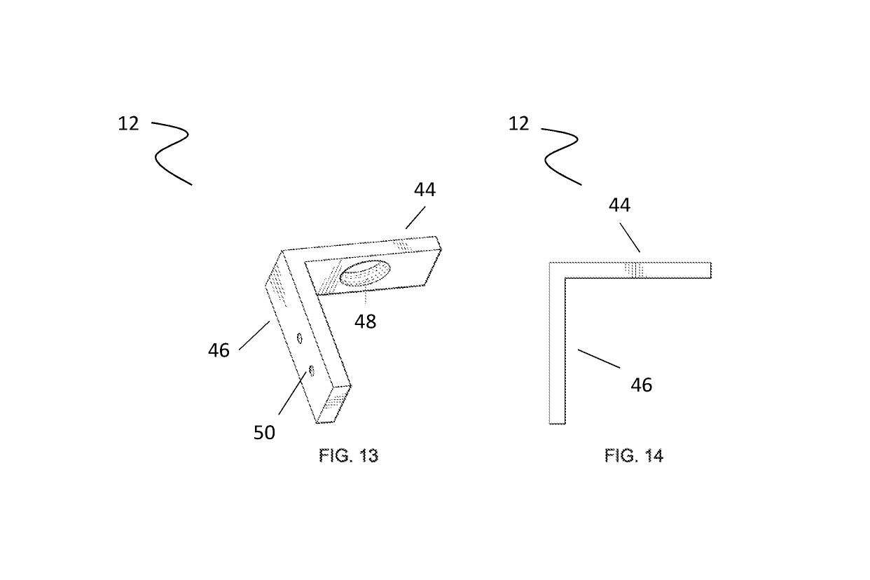

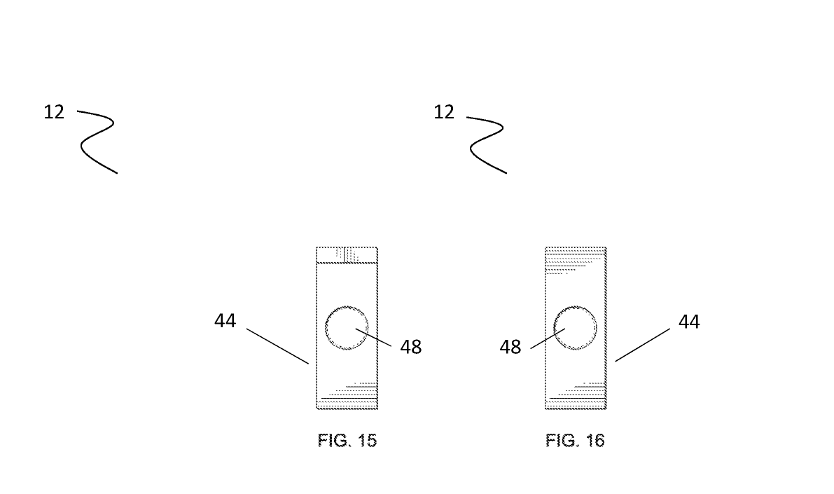

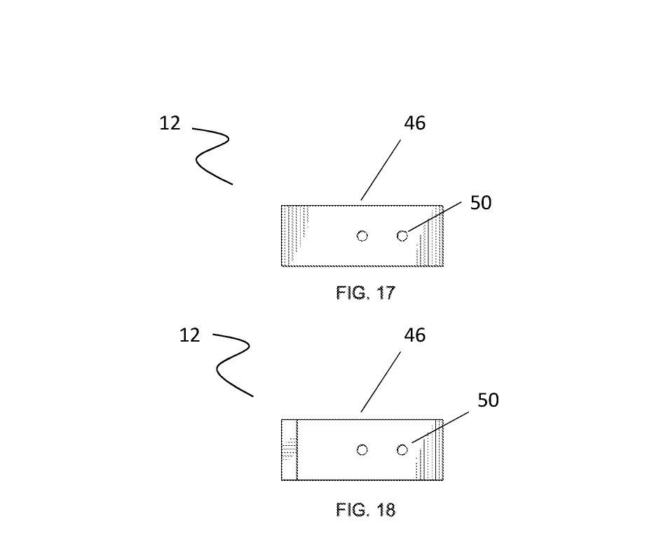

FIGS. 13-18 illustrate various viewpoints of one embodiment of a bracket member 12 with FIG. 14 illustrating a side view, FIG. 15 illustrating a top view, FIG. 16 illustrating a bottom view, FIG. 17 illustrating a front view and FIG. 18 illustrating a rear view. The bracket forms a right angel with one side in communication with the telescoping pole 46 and the perpendicular side extending outward parallel to the ground 44. The bracket comprises at least one large aperture 48 on side 44 and at least one aperture 50 on side 46 which is in communication with the telescoping pole.

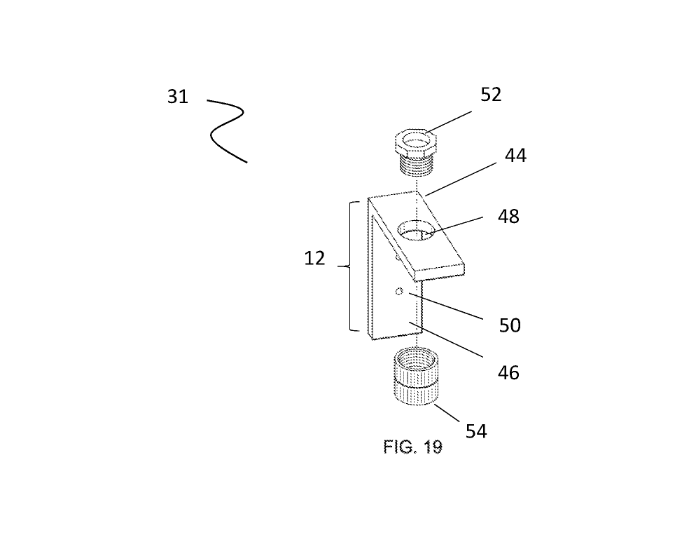

FIG. 19 illustrates one viewpoint of the bracket 12 in one embodiment with the ability to receive hardware via the large aperture 48. In said embodiment, aperture 48 is in communication with male hardware 52 via the top of side 44 and in communication with female hardware 54 via the bottom of side 44.

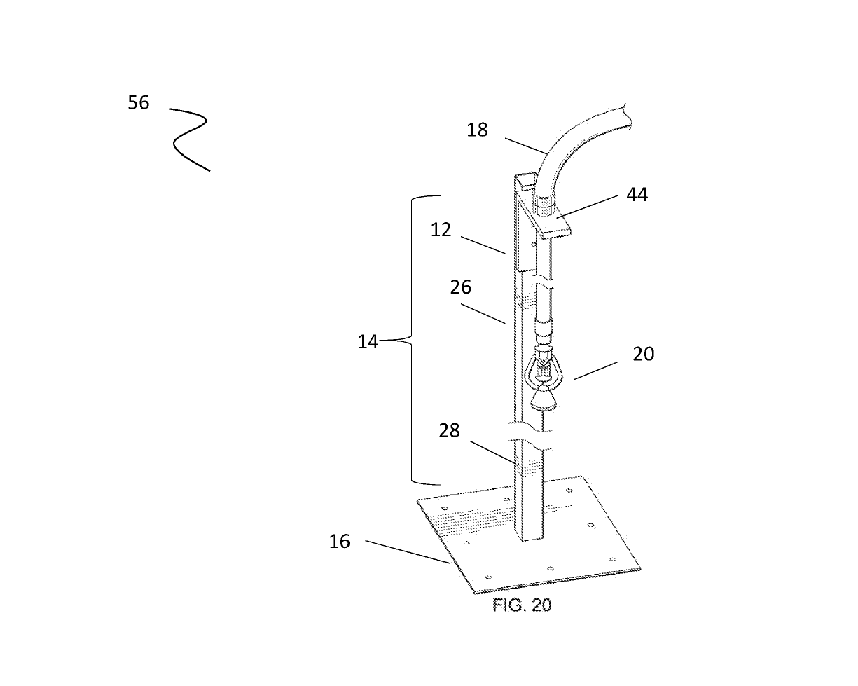

FIG. 20 illustrates another viewpoint of the present apparatus's telescoping pole, bracket, integrating water pressure reducer 30, wobbler sprinkler and water leader hose for inverted water application 56. In one embodiment, the bracket 12 is in communication with the upper portion of the telescoping pole 26 which in communication with the bottom portion 28 which in turn is in communication with the base 16. The bracket 12 is designed to receive different types of system heads like a wobbler sprinkler head 20 and a ticker sprinkler head 24 via the bottom of bracket side 44 using male hardware 52. The bracket is also designed to receive a water leader hose 18 via the top of bracket side 44 using female hardware 54.

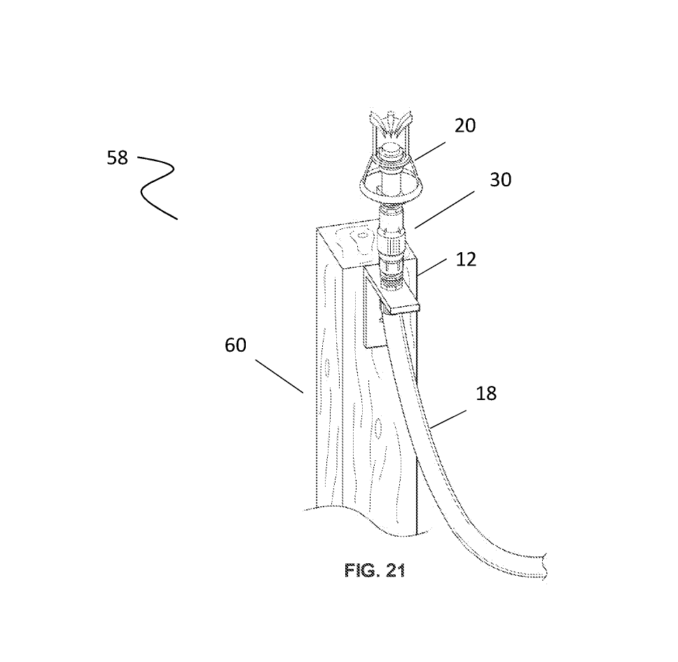

FIG. 21 illustrates another embodiment of the present apparatus's bracket, integrating water pressure reducer 30, wobbler sprinkler and water leader hose for upward water application 58. In the present embodiment, the bracket 12 is in communication with a wooden post 50. The bracket 12 is secured using removable hardware to ensure the attachments stay in place. The wobbler sprinkler 20 is in communication with the bracket 12.

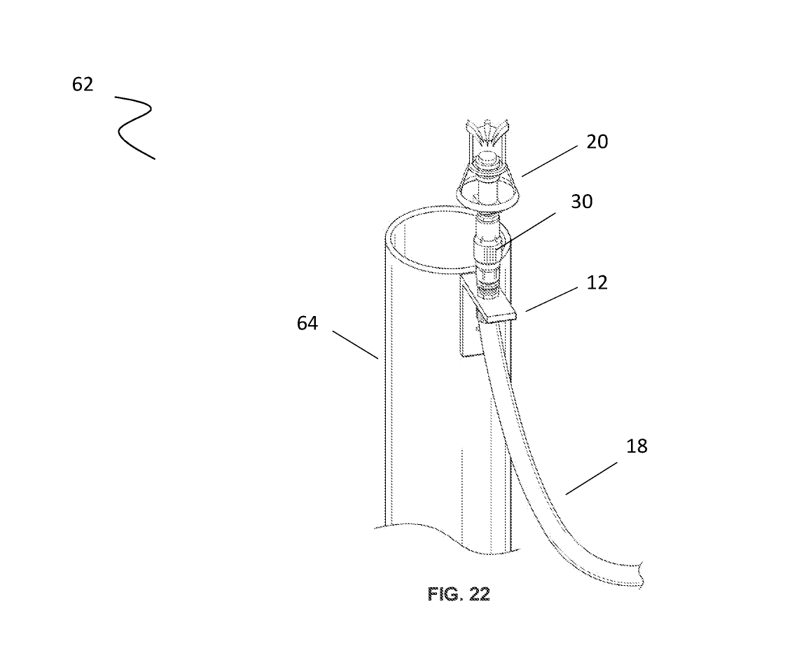

FIG. 22 illustrates another embodiment of the present apparatus's bracket, integrating water pressure reducer 30, wobbler sprinkler and water leader hose for upward water application 62. In the present embodiment, the bracket 12 is in communication with a metal cylindrical post 64. The bracket 12 is secured using removable hardware to ensure the attachments stay in place. The wobbler sprinkler 20 is in communication with the bracket 12.

In a further embodiment, instead of utilizing a singular base 16 structure, the lower portion may be constructed of four (4) retractable base legs and the telescopic pole, which may utilize a push pin mechanism to fold up/down in order to become a uniform parallel unit or by means of an aluminum profile channel post utilizing a nut or corresponding key slot connector in order to achieve precise height, direction and/or location requirements. Thus, the system is designed to be collapsible in order to afford the user ease of transport and storage, while fitting into a minimal area.

Furthermore, the value associated with the ability to easily, rapidly and precisely adjust the telescoping post height and easily, rapidly is of great value and may be applied to yet to be determined uses and industries. The ability to integrate multiple embodiments of the telescoping post is not limited to the horticulture, agriculture, viticulture, landscaping and/or sports industries, but will be applied in other industries where the described telescoping posts are coupled with the ability to rapidly, easily and precisely integrate varying end user specific telescoping poles such as, but not limited to those used with video cameras, picture cameras, lightening detection devices, lights, motion detection devices, boundary/perimeter sensor devices, radar, weather sensing devices.

There has thus been outlined, rather broadly, the more important features of this versatile system in order that the detailed description thereof that follows may be better understood, and in order that the present contribution to the art may be better appreciated. There are additional features of the system that will be described hereinafter and which will form the subject matter of the claims appended hereto.

In this respect, before explaining at least one embodiment of the system in detail, it is to be understood that the system is not limited in its application to the details of construction and to the arrangements of the components set forth in the following description or illustrated in the drawings. The system is capable of other embodiments and of being practiced and carried out in various ways. Also, it is to be understood that the phraseology and terminology employed herein are for the purpose of description and should not be regarded as limiting.

These together with other objects of the system, along with the various features of novelty, which characterize the system, are pointed out with particularity in the claims annexed to and forming a part of this disclosure. For a better understanding of the system, its operating advantages and the specific objects attained by its uses, reference should be made to the accompanying drawings and descriptive matter in which there are illustrated preferred embodiments of the system.

I claim:

1. A multipurpose fluid dispersion unit comprising:
a telescoping pole mechanism comprising an upper portion and a lower portion wherein the upper portion diameter is of larger diameter than the lower portion diameter;
a bracket;
a set of male connectors;
a set of male connectors;
a base mechanism;
a sprinkler apparatus;
a water pressure reducer mechanism;
a leader hose apparatus;
a fence apparatus; and,
a shade cloth apparatus.

2. The multipurpose fluid dispersion unit of claim 1 wherein the telescoping pole mechanism comprises an upper pole portion and a lower pole portion wherein the lower pole portion is smaller than the upper pole portion to allow the smaller portion to fit inside the larger portion of the pole mechanism allowing for height adjustments.

3. The multipurpose fluid dispersion of claim 1 wherein the telescoping pole mechanism further comprises at least one aperture in the upper portion of the pole mechanism and a push pin mechanism in the lower portion, wherein the push pin mechanism depresses to fit snuggly into the corresponding apertures in the upper portion of the telescoping pole mechanism.

4. The multipurpose fluid dispersion of claim 1 wherein the entire telescoping pole mechanism is constructed of materials selected from the group consisting of composites, metal alloys, carbon fiber, metallic material, plastic, polymers.

5. The multipurpose, collapsible, and portable fluid dispersion unit of claim 1, wherein the bracket is constructed of materials selected from the group consisting of composites, metal alloys, carbon fiber, metallic material, plastic, polymers.

6. The multipurpose, collapsible, and portable fluid dispersion unit of claim 1 further comprising a shade cloth apparatus wherein the shade cloth apparatus is secured with a fastener mechanism to the telescoping pole mechanism.

7. The multipurpose, collapsible, and portable fluid dispersion unit of claim 6 wherein the shade cloth apparatus may be selected from the group consisting of polymer, rubberized, composite, metal and alloy.

8. The multipurpose, collapsible, and portable fluid dispersion unit of claim 1 further comprising a fence apparatus wherein the fence apparatus is secured with a fastener mechanism to the telescoping pole mechanism.

9. The multipurpose, collapsible, and portable fluid dispersion unit of claim 1 wherein the sprinkler apparatus is interchangeable comprising either a wobbler sprinkler apparatus or a ticker sprinkler apparatus.

10. The multipurpose, collapsible, and portable fluid dispersion unit of claim 1 wherein the male and female hardware are in communication through the bracket, with the female hardware on either the top or bottom of the bracket and the male hardware on the opposing side of the bracket, allowing for application of the sprinkler apparatus and the leader hose apparatus on either the top or bottom of the present apparatus.

11. The multipurpose, collapsible, and portable fluid dispersion unit of claim 1 wherein the base mechanism consists of at least one aperture and weep hole for reception of the telescoping pole mechanism.

12. The multipurpose, collapsible, and portable fluid dispersion unit of claim 1 further comprising a wobbler sprinkler apparatus and leader hose apparatus for inverted water application.

13. A multipurpose horticulture apparatus comprising:
a telescoping pole mechanism comprising a first section, a second section, a third section and a fourth section wherein the first section diameter is of smaller diameter than the second section diameter, the second section diameter is larger than the third section diameter, and the third section diameter is smaller than the fourth section diameter;
a bracket;
male and female hardware;
a base mechanism;
a sprinkler apparatus;
a water pressure reducer mechanism;
a leader hose apparatus;
a fence apparatus; and,
a shade cloth apparatus.

14. The multipurpose horticulture apparatus of claim 13 further comprising a first section comprising at least one aperture, a second section comprising at least one aperture, a third section with at least one push pin, and a fourth section comprising at least one aperture.

15. A multipurpose horticulture apparatus comprising:
a bracket;
a water pressure reducer mechanism;
male and female hardware;
a leader hose; and,
a sprinkler apparatus.

16. The multipurpose horticulture apparatus of claim 15 wherein the bracket is in communication with either a wooden post or a metal cylindrical pole and is secured using hardware.
